(19) United States
(12) Patent Application Publication
(10) Pub. No.: US 2016/0342745 A1
(43) Pub. Date: Nov. 24, 2016

(54) SYSTEMS AND METHODS FOR LOW-BURDEN CAPTURE AND CREATION OF MEDICAL DATA

(71) Applicant: Praxify Technologies, Inc., Palo Alto, CA (US)

(72) Inventors: Abhijit Manohar Gupta, Pune (IN); Mohan Rao, Pune (IN)

(21) Appl. No.: 15/230,447

(22) Filed: Aug. 7, 2016

Related U.S. Application Data
(63) Continuation of application No. PCT/IN2015/000070, filed on Feb. 5, 2015.

(30) Foreign Application Priority Data
Feb. 7, 2014 (IN) 440/MUM/2014

(51) Int. Cl. G06F 19/00; G06F 3/0488; G06F 17/27; G06F 3/0482

(52) U.S. Cl. CPC G06F 19/322; G06F 3/0482; G06F 3/04883; G06F 17/276; G10L 15/26

(57) ABSTRACT

Healthcare information recorders use a series of processor-driven GUIs that enable low burden entry of healthcare information, including examination information, diagnoses, and treatment/prognosis. Typing of whole words and phrases is not required in the recorders, which may operate with simple touches, gestures, spoken commands, etc., potentially through a touchscreen. A database may store a series of input templates and entry options that reflect likely options for healthcare information needed to be entered. All aspects of healthcare are addressable, including examinations, diagnoses, tests and results, prescriptions, treatments, and prognoses. Input into the recorders refines later operations, permitting suggestions, auto-completion, and better solicitation of information in a sequence of GUIs. User input through recorders may thus be both simplified and comprehensive and stored in connection with relevant recordation information such as date and time, attending physician, or by patient identifier.

### RELATED APPLICATIONS

This application claims priority under 35 U.S.C. §120 to, and is a continuation of, co-pending International Application PCT/IN2015/000070, filed Feb. 5, 2015 and designating the US, which claims priority to Indian Application 440/MUM/2014, filed Feb. 7, 2014, such Indian Application also being claimed priority to under 35 U.S.C. §119. These Indian and International applications are incorporated by reference herein in their entireties, with the exception of any disclaimers and redefinitions, including statements of the present invention. US Design Application 29/500,027, filed Aug. 20, 2014, is further incorporated by reference herein in its entirety.

### BACKGROUND

Healthcare includes surgical procedures, examination procedures, diagnostic procedures, prognosis procedures, and several related activities. Medical professionals typically administer such healthcare while systematically documenting the patient's medical history and care over time, and potentially over multiple medical professionals, using a medical record, health record, medical chart, etc. Such medical records conventionally include notes and data relating to a patient's healthcare and client-patient interaction. For example, diagnoses, medical procedure history, vital signs and symptoms data, test results, drugs and medication data, prognoses, visit notes, insurance data, demographics, health and family histories, etc. may all he captured and recorded in a patient's medical record, together with existing personal health information such as name, birth date, blood type, and emergency contact; date of last physical; dates and results of tests and screenings; major illnesses and surgeries, with dates; lists of medicines, dosages and how long they are being taken; allergies; chronic diseases; history of illnesses in the patient's family, etc.

Laws and regulations, and well as economics, have encouraged adoption of computerized medical record technology worldwide. For example, in the US, the 2009 HITECH Act encourages and controls adoption of health information technology and creation of a nationwide network of electronic health records. Additionally, conservation efforts and increased cost of paper records have encouraged widespread adoption of electronic records and computerized, paperless systems and methods for medical records and medical practice management.

Maintaining complete and accurate medical records for use in healthcare administration aids the healthcare provider and patient from a medical and legal perspective. Conventionally, medical records are formulated, supplemented, and/or retrieved with patient management software (PMS) installed on a computer within a healthcare IT system. PMS is used to acquire medical information from a medical device in the treatment or diagnosis of a patient. Information from a PMS portal, such as an on-screen display of a medical record, can also be used as an aid to supplement the judgment and decision of a doctor. Once specific piece of healthcare IT includes mobile devices installed with PMS and specific interfaces with medical devices. For example, a tablet computing device, smart phone, and/or PDAs are often employed in healthcare IT with PMS.

### SUMMARY

Example embodiments and methods to record healthcare information in a computer-based format in a low burden-manner to facilitate full recordation with minimal distraction by healthcare professionals. For example, systems and methods may not require typing or other symbolic input but rather operate with simple touches, gestures, spoken commands, etc. to record comprehensive healthcare information for a patient. Input may be entered through a display, such as a touchscreen, displaying screens that are rendered by and given functionality by a computer processor associated with the screen. In order to minimize entry burden, example systems and methods may include one or more databases that store a set of screens or interfaces that intuitively present healthcare information and entry fields and options for selections. Each screen may address a different aspect of healthcare, such as a sequence of screens that move through the examination process, each more detailed and based in a hierarchical manner on a previous screen. In this way, input during initial stages of examination, or at a coarse level of examination, may guide or streamline later screens and selection options so as to focus user entry options and give useful suggestions for completing information or simplify fields for entry of relevant healthcare information. Entered input into screens can thus advance options for later input, and all input healthcare information may be recorded in association with a particular point in time, a particular patient, a particular healthcare provider, and an individual healthcare administration.

### BRIEF DESCRIPTIONS OF THE DRAWINGS

Example embodiments will become more apparent by describing, in detail, the attached drawings, wherein like elements are represented by like reference numerals, which are given by way of illustration only and thus do not limit the example embodiments herein.

FIG. 1 is a schematic of an example embodiment healthcare input system.

FIG. 2 is a schematic of another example embodiment healthcare input system.

FIG. 3 is an illustration of an example embodiment GUI on a computerized display.

FIG. 4 is a schematic of another example embodiment healthcare input system.

FIG. 5 is an illustration of another example embodiment GUI on a computerized display.

FIG. 6 is a schematic of another example embodiment healthcare input system.

FIG. 7 is an illustration of another example embodiment GUI on a computerized display.

FIG. 8 is a schematic of another example embodiment healthcare input system.

FIG. 9 is an illustration of another example embodiment GUI on a computerized display.

FIG. 10 is an illustration of another example embodiment GUI on a computerized display.

FIG. 11 is a schematic of another example embodiment healthcare input system.

FIG. 12 is an illustration of another example embodiment GUI on a computerized display.

FIG. 13 is a schematic of another example embodiment healthcare input system.

### DETAILED DESCRIPTION

This is a patent document, and general broad rules of construction should be applied when reading it. Everything described and shown in this document is an example of subject matter falling within the scope of the claims, appended below. Any specific structural and functional details disclosed herein are merely for purposes of describing how to make and use example embodiments. Several different embodiments not specifically disclosed herein may fall within the claim scope; as such, the claims may be embodied in many alternate forms and should not be construed as limited to only example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when element(s) are referred to in relation to one another, such as being “connected,” “coupled,” “mated,” “attached,” or “fixed” to another element(s), the relationship can be direct or with other intervening elements. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). Similarly, a term such as “connected” for communications purposes includes all variations of information exchange routes between two devices, including intermediary devices, networks, etc., connected wirelessly or not.

As used herein, the singular forms “a”, “an,” and “the” are intended to include both the singular and plural forms, unless the language explicitly indicates otherwise with terms like “only a single element.” It will be further understood that the terms “comprises,” “comprising,” “includes,” and/or “including,” when used herein, specify the presence of stated features, values, steps, operations, elements, and/or components, but do not themselves preclude the presence or addition of one or more other features, values, steps, operations, elements, components, and/or groups thereof.

As used herein, “Electronic Medical Record” refers to storing healthcare information in an electronic format as opposed to a paper format. An “examination” refers to a physical examination, a medical examination, or a clinical examination which generally relates to a process by which a medical professional investigates the body of a patient for signs of disease. An examination generally follows the taking of the medical history—an account of the symptoms as experienced by the patient. Together with the medical history, the physical examination aids in determining the correct diagnosis and devising the treatment plan. This data then becomes part of the medical record.

As used herein, “diagnosis” refers to the identification of the nature and cause of a certain phenomenon. Diagnosis is used in many different disciplines with variations in the use of logics, analytics, and experience to determine cause and effect. In medial parlance, a diagnosis includes both the process of attempting to determine or identify a possible disease or disorder and to the opinion reached by this process. Medical diagnosis or the actual process of making a diagnosis is a cognitive process.

As used herein, a “prescription” refers to orders to be performed by a patient, caretaker, nurse, pharmacist, physician, other therapist, or by automated equipment. These orders are, typically, given by qualified practitioners. Typically, prescription comprises medicine(s) name, directions relating to the medicine(s), dosages with intervals to take the medicine(s), route of using the medicine(s), duration to take the medicine(s), remarks pertaining to medicine(s), and the like.

As used herein, “treatment plans” refer to road maps that a patient will follow on his or her journey through treatment. Treatment goals and objectives are based on the most recent diagnostic assessment. Specific strategies and methods for treating need to be identified by the diagnostic assessment. Schedule for accomplishing goals and objectives need to be documented. Responsibility for providing each treatment component is stated, recorded, and followed. Health status and progress, including changes in functioning are to be documented.

As used herein, “prognosis” refers to predicting the likely outcome of one's current standing. Prognosis relates to the prospect of recovery as anticipated from the usual course of disease or peculiarities of the case. A complete prognosis includes the expected duration, the function, and a description of the course of the disease, such as progressive decline, intermittent crisis, or sudden, unpredictable crisis.

As used herein, “verbal typing” includes manual input of expressive words or phrases through a keyboard or other input device capable of forming verbal constructs. As such, input that is not verbal typing, like some inputs useable in example embodiments, includes any spoken or tactile communication that does not include typing words or phrases, including clicking a mouse, typing an accept key such as spacebar or a single letter, speaking, touching or dragging a touchscreen, gesturing, etc.

It should also be noted that the structures and operations discussed below may occur out of the order described and/or noted in the figures. For example, two operations and/or figures shown in succession may in fact be executed concurrently or may be executed in the reverse order, depending upon the functionality/acts involved. Similarly, individual operations within example methods described below may be executed repetitively, individually or sequentially, so as to provide looping or other series of operations. It should be presumed that any embodiment having features and functionality described below, in any workable combination, falls within the scope of example embodiments.

The inventors have recognized that it is necessary to have an intelligent system and method which provides for an electronic template for recording examinations in the electronic healthcare record context. Examinations need to be intuitive, adapt to doctor behavior, and require minimal typing or other manual input. The inventors have further recognized a need to have a record of items which aid diagnosis that is selected from examinations (vital and physical), tests and results, past data, prevalent viruses or epidemics, or the like in an electronic format, as well as electronic documented versions of treatment plans. This treatment plan needs to be in correlation with diagnosis and acts as a feedback mechanism along with milestones. It is further desired to have an intelligent system and method of recording healthcare interactions that provides an electronic prescription in an intuitive manner that learns doctor behavior, and requires minimal manual input. The inventors have further recognized a need for an electronic format for tests and results that is intuitive and uses pre-fed data to make documentation easier. There is a further need to record date-stamped and/or time-stamped patient condition further to treatment to verify whether a diagnosis was correct and whether a treatment plan is being followed. A feedback can be provided based on this data. Hence, it is necessary to have an intelligent system and method which provides for an electronic healthcare recording system that is intuitive, learns doctor behavior, and allows for easy input. Example embodiments discussed below overcome these and other newly-recognized problems by allowing users to record and view electronic medical and health records with minimal burden.

The present invention is systems and methods for recording healthcare information without requiring typing. The present invention is not—and the inventors explicitly disclaim—scope over a bare transitory signal or an abstract idea per se. While transitory signals and general concepts of arranging human behavior, comparing information and using rulesets based thereon, and categorizing information are useable with or in the present invention, the present invention is limited to particular implementations of those signals and concepts to improve specific articles of health information technology, such as specifically-configured patient-management hardware and software. In contrast to the present invention, the few example embodiments and example methods discussed below illustrate just a subset of the variety of different configurations that can be used as and/or in connection with the present invention.

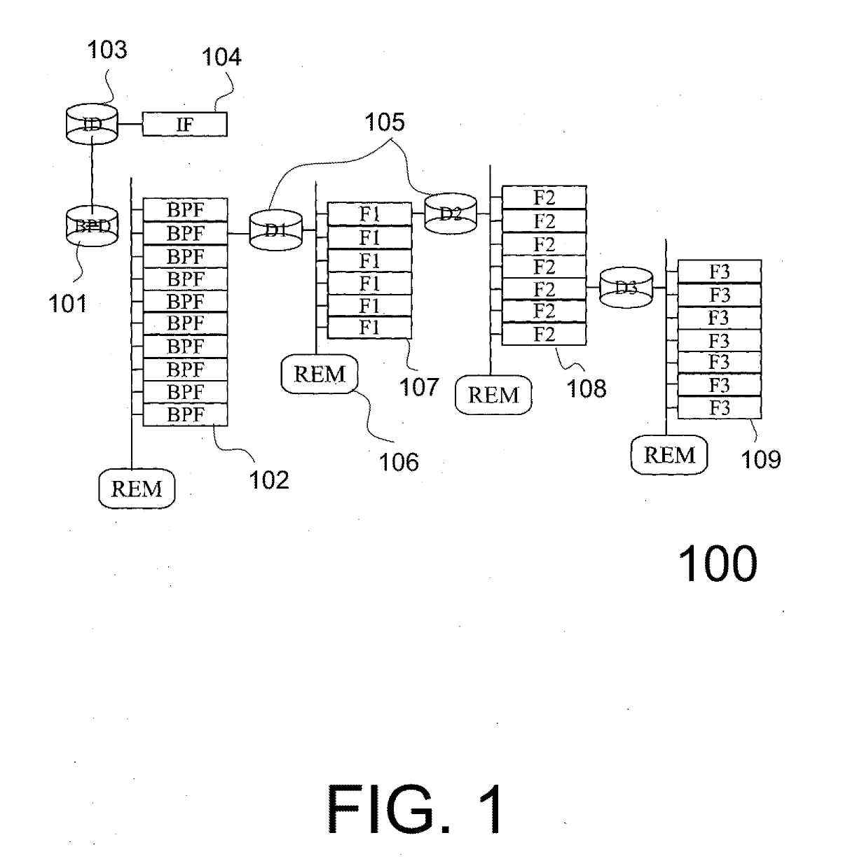

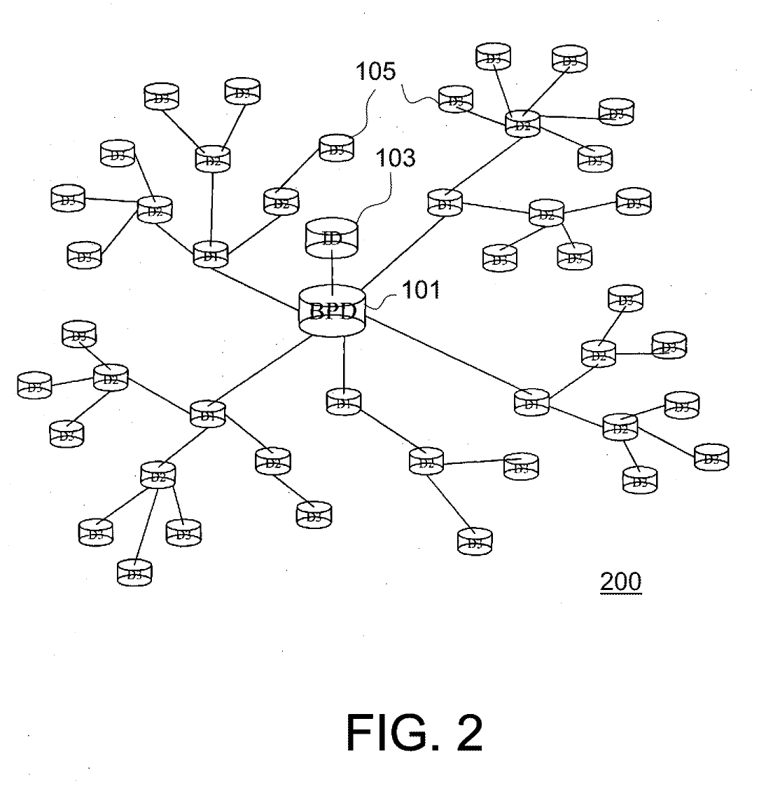

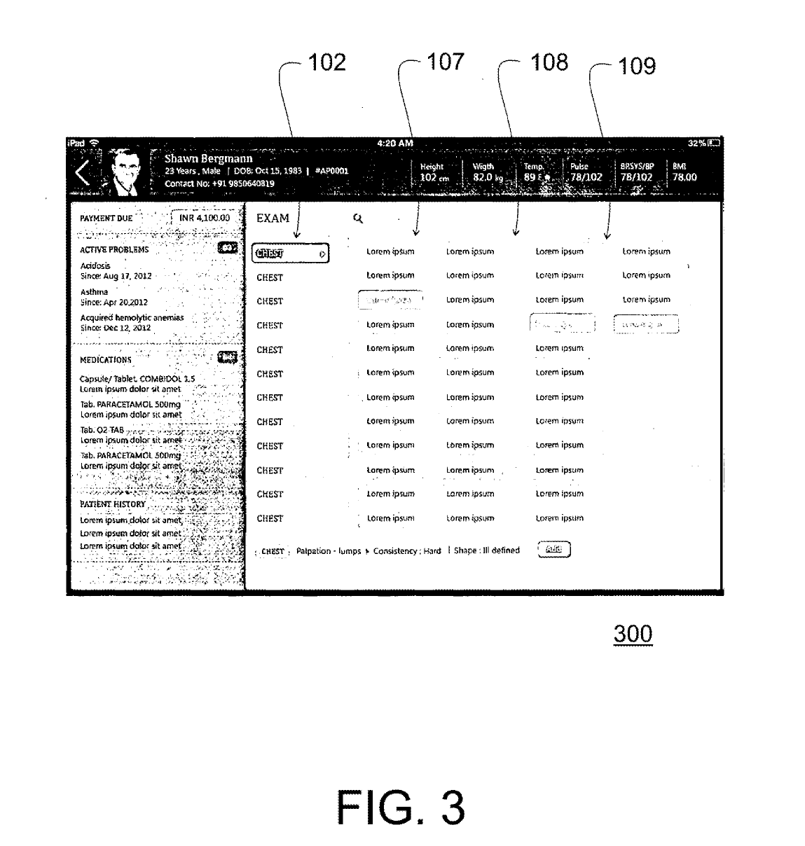

FIG. 1 illustrates a specially-configured hardware or software schematic that makes up an example embodiment healthcare input system 100. FIG. 2 illustrates another example system 200 with similar parts, but in a relational configuration. FIG. 3 is an illustration of an example embodiment GUI 300 rendered by example embodiment systems and methods on a computerized display.

As shown in FIG. 1, a body parts database 101 (BPD) configured to store a list of body parts. The body parts may be related to some illnesses, for example. Body parts database 101 may store, for example, chest, leg, kidney, wrist, breast, eye, knee, shoulder, elbow, neck, back, spine, etc. in a relational database or other storage format. Body parts database 101 is linked to body parts field 102 (BPF) configured to display the body parts from database 101 in a selectable manner such that a user may select the body part from GUI 300 (FIG. 3), such as through a click, gesture, and/or touch, for example. For example, a doctor may select a body part through body parts field 102, which may highlight the selection.

As shown in FIG. 1, example embodiment system 100 may include an illnesses database (ID) 103 storing a list of illnesses. Illnesses database 103 is linked with illnesses field 104 (IF) configured to display an illness from database 103 on GUI 300 (FIG. 3). For example, a doctor may select an illness from database 103 through a click, gesture, and/or touch, and field 104 may highlight the selection.

As shown in FIG. 1, one or more sets of databases 105 (D1, D2, D3) are linked with each other in a hierarchical manner so as to form a one-to-many correlation for every item in a preceding database 105. A relationship manager 106 (REM) is configured to establish a relationship between items of successive databases 105. In this way each item may be activated or populated upon selection of an item of a previous database 105. For example, each item in a preceding database, when selected, may populate multiple applicable fields in successive databases. For example, as shown in FIG. 3, selection of an item from a body parts field 102 may populate subsequent field 107 with items correlating to the item from an associated database.

A first database 105 (D1) may relate to a first set of items that correlate to a first level of examination findings or reports that populate a first set of fields 107 (F1). First fields 107 may be displayed in a column format. Once a body part is selected even in a successive database, fields from the corresponding first database 105 (D1) relating to the body part may be populated. Selection may be achieved, for example, by a click, gesture, or other input. A second set of databases 105 (D2) relate to a second set of items for attributes related to the selected first item from the first fields 107. These second set of items populate a second set of fields 108 (F2) upon selection of a first corresponding item 107 (F1). A third set of databases 105 (D3) relate to a third set of items for a second set of attributes related to the selected second item from the second fields 108. These third set populated a third set of fields (F3) 109 upon selection of a second corresponding item.

Multiple successive databases 105 may be provided, varying in depth or succession depending upon the body part and attributes for examination associated with the body part. Selection of a body part from body parts database 101 may establish the relationship among sets (D1, D2, D3) of databases 105 for each level of examination, For example, as shown in FIG. 3, an item 107 at the first level of examination could be visual examination, physical examination, third part examination, machine related examination, invasive examination, non-invasive examination, scanned examination, and/or other examination findings. Selection from the first level results in turn presents a relevant item 108 from the second level that relate to the first item, as ordered by relationship manager 106. Of course, multiple selections could be made in a set of items from any database at any given level, and preexisting or generated rulesets may limit or require maximum and minimum numbers of selections for any database 105.

Example embodiment healthcare input systems may receive input and record healthcare information based at least on inspection, palpation, auscultation, and assessment. These four parameters may relate to any body part being examined so that a relationship is established in a hierarchical manner in an examination record. For example, a doctor may use example embodiment to select a body part with a body parts field and database, and the four parameters may be mapped to each body part for recordation. This mapping allows for an intuitive and complete recordation of a healthcare examination of a selected body part.

As a complete example using FIGS. 1-3, during a patient-doctor interaction, a doctor may select a body part item from body parts field 102 linked to body parts database 101, for example, “chest.” The selection of chest causes relationship manager 106 to activate a second related database 105 which further results in populating second set of fields 107 from second database 105 (D1). The doctor then may select “palpations-lumps” from the second set of fields 107. The selection of palpation-lumps causes relationship manager 106 to activate a third related database 105 (D2) which further results in populating third set of fields 108 from third database 105 (D2). The doctor may then select “hand” from the third set of fields 108. The selection of hand causes relationship manager 106 to activate a fourth related database 105 (D3) which further results in populating fourth set of fields 109 from fourth database 105 (D3). The doctor may then select “ill defined” from fourth set of fields 109. Of course, for a different selected body part, the databases that flow and that are linked may vary in accordance with the attributes that are present and that are selected.

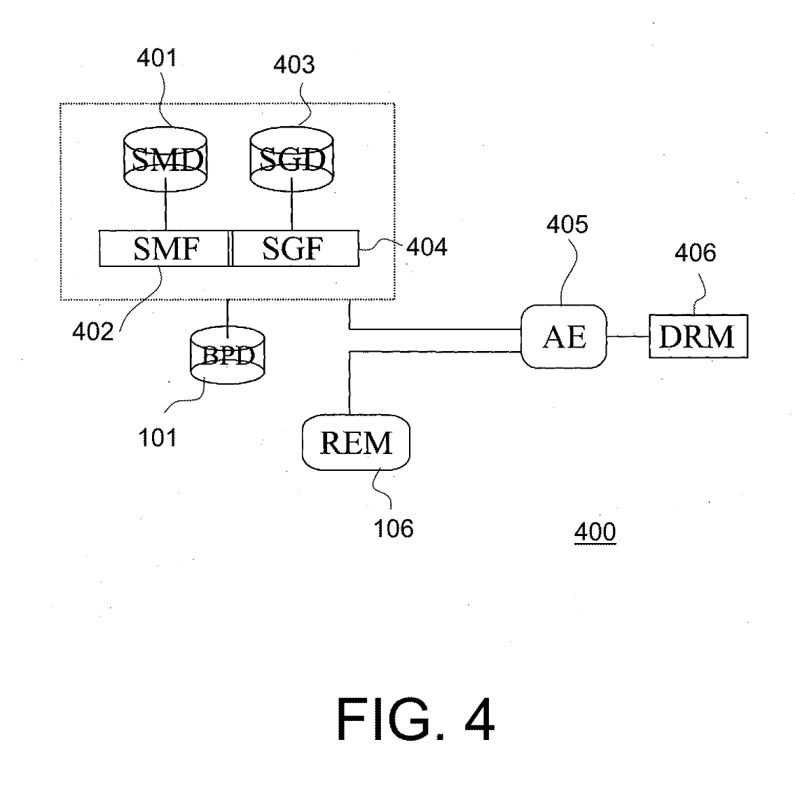

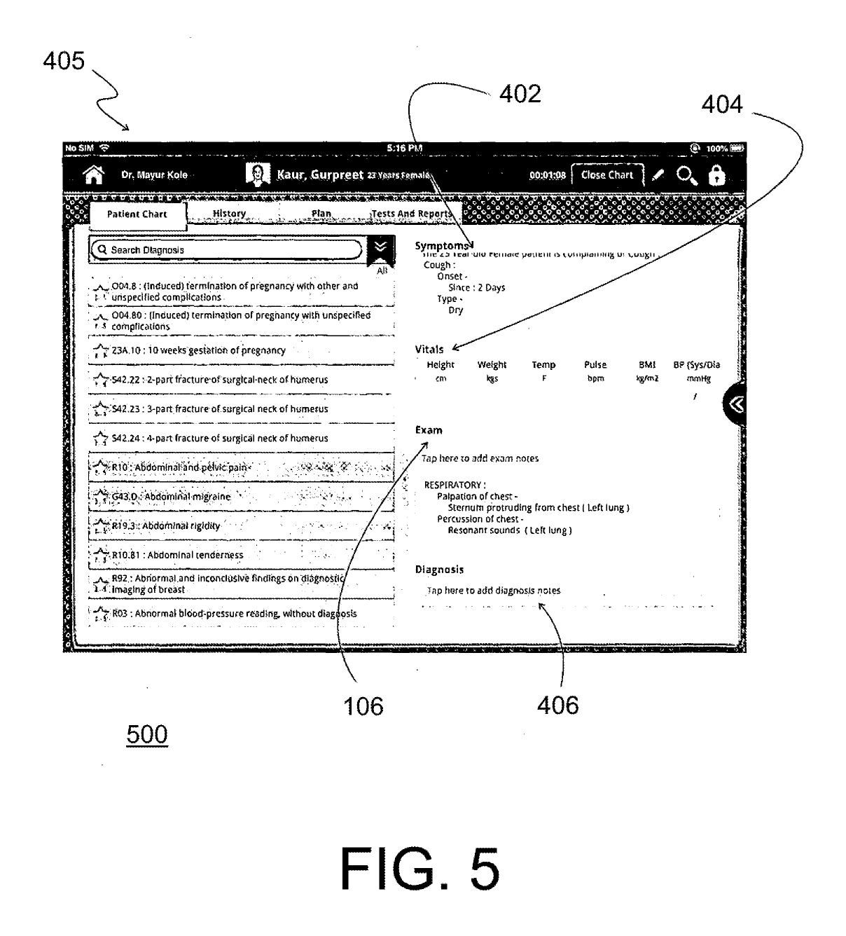

FIG. 4 illustrates a specially-configured hardware or software schematic that makes up an example embodiment healthcare input system 400. FIG. 5 is an illustration of an example embodiment GUI 500 rendered by example embodiment systems and methods on a computerized display.

As shown in FIG. 4, symptoms database 401 (SMD) stores a list of symptoms. The symptoms stored in database 401 may be linked to body parts from body parts database 101. Depending upon a body part selected, corresponding symptoms may be activated and displayed in GUI 500 for selection in a symptoms field 402 (SMF) linked with symptoms database 101. For example, a doctor may select a symptom, through touch, gesture, click, etc., from symptoms field 402 displaying symptoms from symptoms database 401 based on a selected body part, and such selection may be highlighted. Symptoms database 401 and symptoms field 402 are linked with a parameter entry field where a user may enter various parameters or other characteristics of a selected symptom, such as time duration, time of occurrence, types, conditions, complaints, and the like.

As seen in FIG. 4, signs database 403 (SGD) stores a list of signs that may be linked to body parts from body parts database 101. Signs database 403 is linked with signs field 404 (SGF) that may display signs from database 403 corresponding to a body part that is selected. For example, a may select a sign from signs field 404 on GUI 500, and such selection may be highlighted. Signs from database 403 and displayable through field 404 may include time duration, time of occurrence, types, conditions, complaints, and the like associated characteristics.

As seen in FIG. 4, aggregation engine 405 (AE) is configured to aggregate the signs, symptoms, and results of examination proceedings selected or input, such as through GUI 500. A view of these aggregated data may be displayed on GUI 500 or otherwise provided to user. Diagnosis recorder 406 (DRM) is configured to record a diagnosis for a doctor-patient encounter based on, or in association with, the aggregated data. The diagnosis is time-stamped, date-stamped, and per doctor-patient encounter; in this way, each diagnosis recorded in recorder 406 contains a specific date and doctor's details as well as patient's details. Diagnosis recorder 406 may display a chronology of previous diagnoses, per patient, on GUI 500.

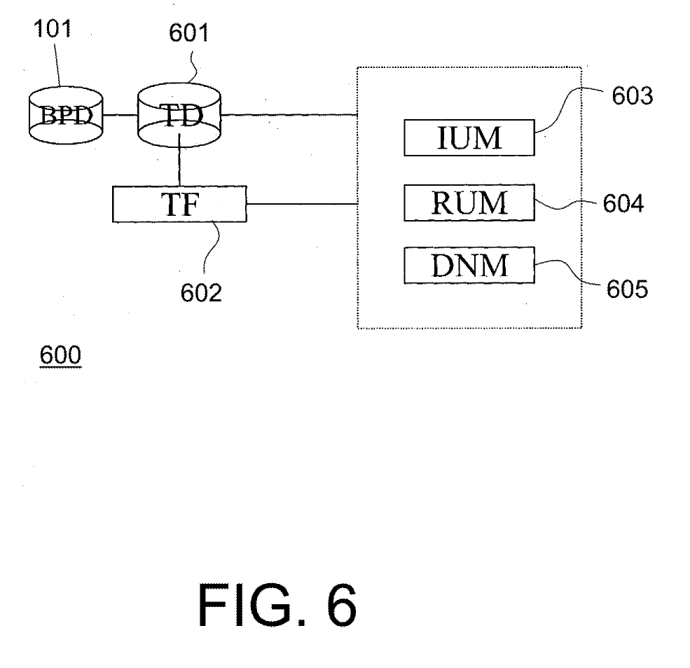

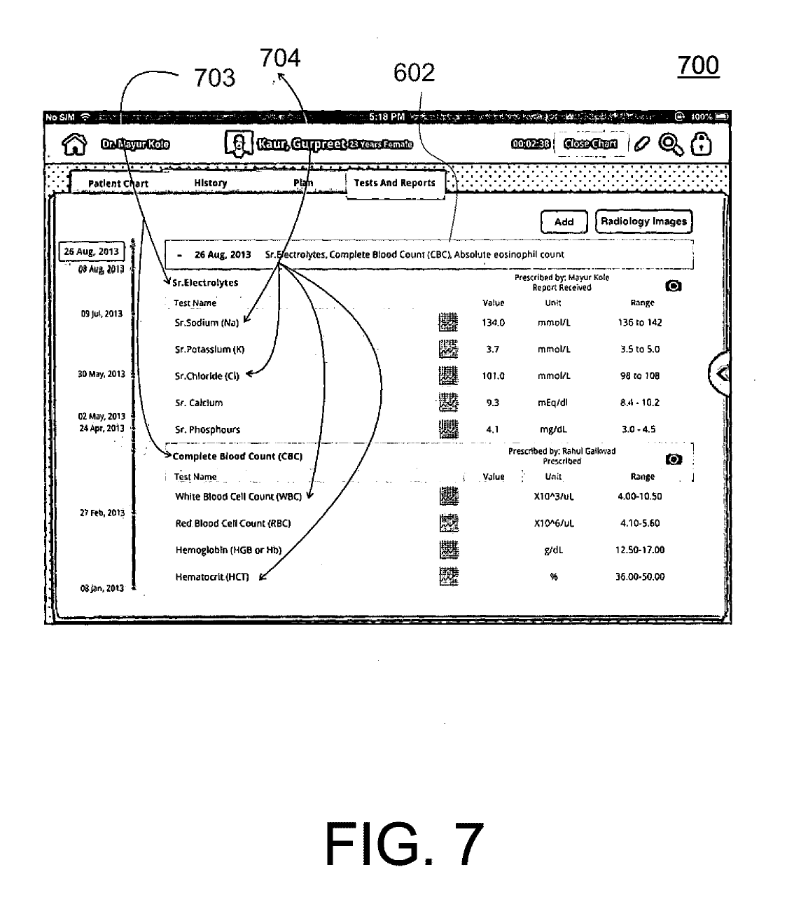

FIG. 6 illustrates a specially-configured hardware or software schematic that makes up an example embodiment healthcare input system 600. FIG. 7 is an illustration of an example embodiment GUI 700 rendered by example embodiment systems and methods on a computerized display.

As seen in FIG. 6, tests database 601 (ID) stores a list of tests that can be prescribed to a patient. Tests stored in database 601 may be linked to body parts from body parts database 101, and tests corresponding with selected body parts may be displayed in tests field 602 (TF) by tests database 601. For example, a doctor may select a test from database 601 through tests field 602 in GUI 700, and such selection may be highlighted. Tests field 602 may include a test header 703 and corresponding elements 704 format. Image uploader 603 (IUM) is configured to upload images in relation to a selected test. For example, images uploaded by uploader 603 may be radiology images, X-ray images, CT images, or the like. Each test prescribed may be stored with specific doctor-patient interaction information as well as doctor and patient information for the test.

Results uploader 604 (RUM) is configured to upload results in relation to a selected test. Results uploader 604 in particular may be remotely accessible, such as at locations where tests are conducted. Association and access to for uploads can be pre-authorized in relation to doctor settings, patient settings, administrator settings, etc. Tests and associated results may be stored with time-stamps and date-stamps and displayed in chronological order on example GUI 700. Definer 605 (DM) is configured to receive and store definitions of units, ranges, and any other test parameter, and these definitions may be displayed in GUI 700 as normal or standard results alongside actual results data received by uploader 604.

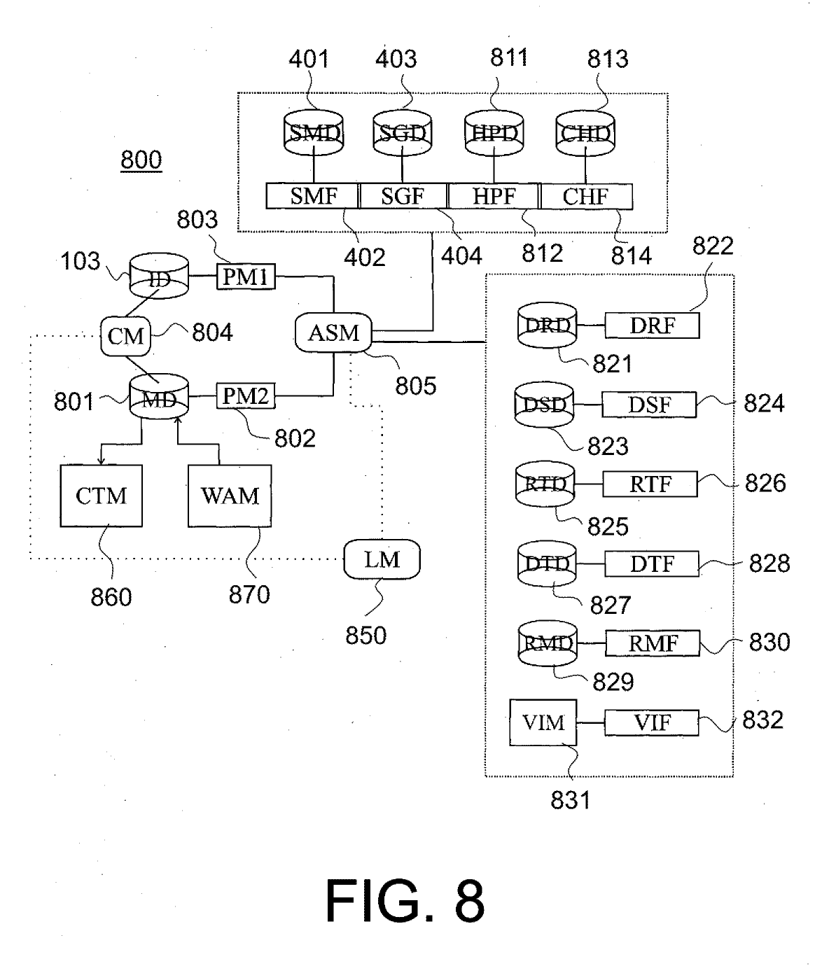

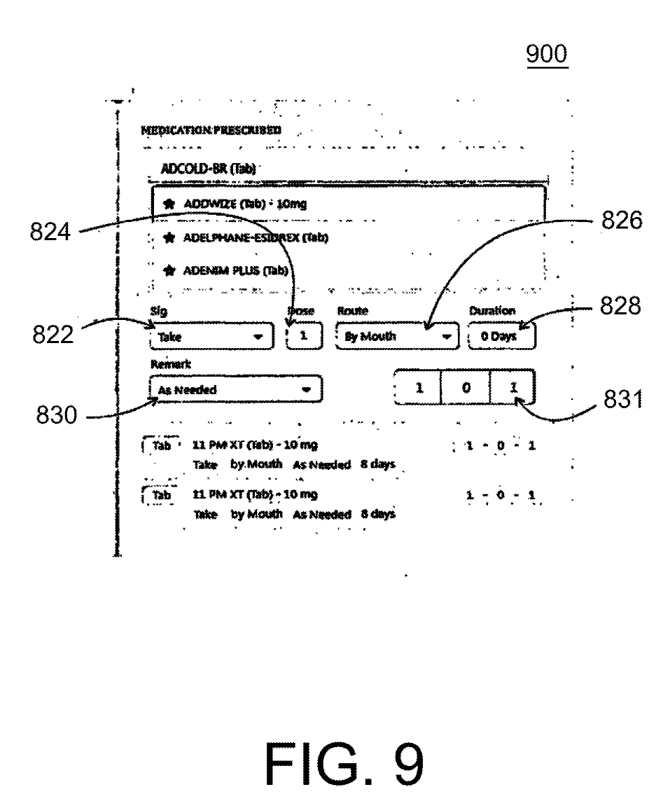

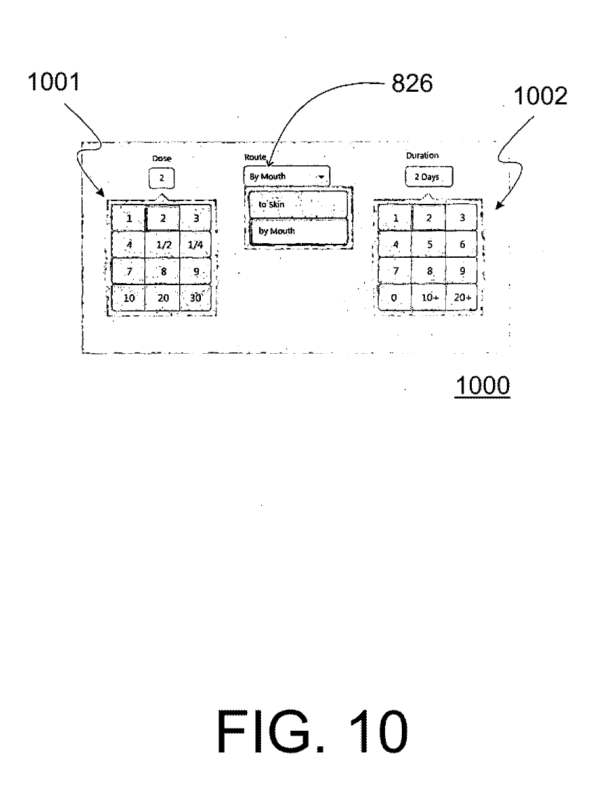

FIG. 8 illustrates a specially-configured hardware or software schematic that makes up an example embodiment healthcare input system 800. FIG. 9 is an illustration of an example embodiment GUI 900 rendered by example embodiment systems and methods on a computerized display. FIG. 10 is an illustration of an example embodiment GUI 1000 rendered by example embodiment systems and methods on a computerized display.

As shown in FIG. 8, illnesses database 103 (ID) is configured to activate a first populator 803 (PM1) that prompts further actions and/or populates further fields in example embodiment GUIs. Medicines database 801 (MD) stores a list of medicines; these medicines are selectable from a drop-down list as shown in example embodiment GUI 900. Medicines can be pre-populated or pre-activated or pre-highlighted in GUI 900, upon selection of an illness from the illnesses database 103 (ID) through correlator 804 (CM) that correlates illnesses to medicines, through pre-defined rules, through machine learning, and/or other input. For example, correlator 804 may generate correlations through artificial neural network mechanisms and fuzzy logic systems based on previous selected medicines or other information. When a user selects a medicine, a second populator 802 (PM2) may prompt further actions and/or populate further fields in example embodiment GUIs.

As seen in FIG. 9, medicine names can be typed in a search bar. As shown in FIG. 8, auto-suggestor 805 (ASM) can pop up or suggest medicines starting with initially-entered letters and/or suggest similar or corrected medicines based on full input. Auto-suggestor 805 is further configured to populate fields relating to symptoms field 402, history of present illness field 812 (HPF), basic clinical history field 814 (CHF), and/or signs field 404, based on a selected illness from illness database 103. In this way, a doctor for example, may serially select items in these fields from an associated database, such as present illness database 811 (HPD), basic clinical history database 813 (CHD), etc., through manual entry or auto-suggestion.

As shown in FIG. 8, directions database 821 (DRD) is configured to store directions in association with particular medicines. Medicines can be administered in several ways, including oral and injection. Directions database 821 is linked to a directions field 822 (DRF) that displays directions associated with a selection. Directions database 821 (DRD) is correlated with second populator 802 (PM2) so as to populate directions based on rules or other pre-defined logic. Second populator 802 may further populate directions based on machine learning that accounts for doctor's prescriptions commonly made in correlation with an illness from illnesses database 103, a symptom from the symptoms database 401, items from history of present illness database 811, and/or items from basic clinical history database 813.

As shown in FTG. 8, dosages database 823 (DSD) stores dosages correlated with a selected medicine. Dosages database 823 is linked to dosages field 824 (DSF) that displays dosages, in whole or decimal format for example, from database 823 as shown in example GUI 900 of FIG. 9. Dosages database 823 may be correlated with second populator 802 to populate dosages based on pre-defined rules, machine learning based on previous entries, or other input as discussed above. Routes database 825 (RTD) stores administration routes in relation to the selected medicine. For example, the route may be an oral route or an intravenous route or a topical route. Routes database 825 is linked to routes field 826 (RTF) that displays the routes on GUI 900. Routes database 825 may be correlated with second populator 802 to populate duration based on pre-defined logic, the above-described machine learning, and/or other input.

As shown in FIG. 8, duration database 827 (DTD) stores administration duration in relation to a selected medicine, such as a number of days. Duration database 827 is linked to a duration field 828 (DTF) that displays the duration on GUI 900 (FIG. 9). Duration database 827 may be correlated with the second populator 802 to populate duration based on pre-defined logic, the above-described machine learning, and/or other input. As shown in FIG. 8, remarks database 829 (RMD) stores remarks input by a user in relation to the selected medicine. For example, the remarks may be specific or general instructions in relation to the medicine, including terms such as, “as needed,” “at night,” “after dinner,” “on empty stomach,” “after eating something” etc. Remarks database 829 is linked to remarks field 830 (RMF) that displays the remarks from database 829 in GUI 900 (FIG. 9). Remarks database 829 may be correlated with second populator 802 to populate remarks based on pre-defined logic, the above-discussed machine learning, and/or other input. As shown in FIG. 8, visual indicator 831 (VIM) indicates dosages in relation to intervals of dosages per day. Visual indicator 831 is linked to visual indicating field 832 (VIF) that displays the dosages in terms of intervals per day from indicator 831 on GUI 900 (FIG. 9). Visual indicator 831 may be correlated with second populator 802 to populate remarks based on pre-defined logic, the above-discussed machine learning, and/or other input.

As seen, selection of a medication can control a number of entries displayed in fields associated with databases such as directions field 822, dosage field 824, routes field 826, visual indicating field 832, duration field 828, and/or remarks field 830. Similarly, selection of an illness can populate these fields with associated entries

As seen in FIG. 10, several input fields in example embodiment GUI 1000 may provide touch-, click-, or gesture-based inputs for a user to input data into example systems and methods. A first numerical keypad 1001 in virtual form may provide inputs for dosages by including a decimal point and/or fractional input. A second numerical keypad 1002 in virtual form may provide inputs for duration.

As seen in FIG. 8, a learning controller 850 (LM) is configured to learn correlations between entered dosages and illnesses, dosages and symptoms, dosages and items of present illness history, and/or dosages and items of basic clinical history. Learning controller 850 is intelligently coupled with first populator 803 and second populator 802. Learning controller 850 may record and identify trends in previous inputs between selected medicines, illnesses and other inputs in order to provide the above-described machine learning.

As shown in FIG. 8, counter 860 (CTM) counts frequency of selection of particular medicines in relation to several inputs. The recorded frequency can be correlated with and/or supplement trends in learning controller 850. In this way, a medicine count and frequency versus to specific illnesses, doctors, patients, and/or per patient-doctor interaction can be calculated by counter 860 and learning controller 850. A weight assigner 870 (WAM) is configured to assign pre-defined weights for a medicine in relation to input and other parameters. These parameters may be, for example, selection frequency, illness quotient, advertisement quotient, user-defined parameters, etc. The assigned weights can be used in a search engine for a medicine recommendation. Medicine assignment in this way can provide useful feedback to interested parties such as medical representative, pharmaceutical companies, or the like.

Example embodiments may further include a unique identifier generator configured to generate a unique identifier for each patient. The unique identifier generator may be linked to a unique identifier database tagged correspondingly with patient identity, referring doctor identity, as well as prescription databases. A dynamic link generator is configured to dynamically link each generated unique identifier with a medication database in a manner such that medications prescribed by a doctor are activated and communicatively coupled to the unique identifier. In this way, prescriptions and all other information may be managed on a par patient basis. There may be a time bar that prevents a particular medication from being prescribed within a certain time frame to a same patient. Pharmacies and other medical point-of-sales may have access to and read unique patient identifiers to retrieve medication data relating to any presenting patient. This provides for paperless, authenticated, warranted, seamless prescription fulfillment.

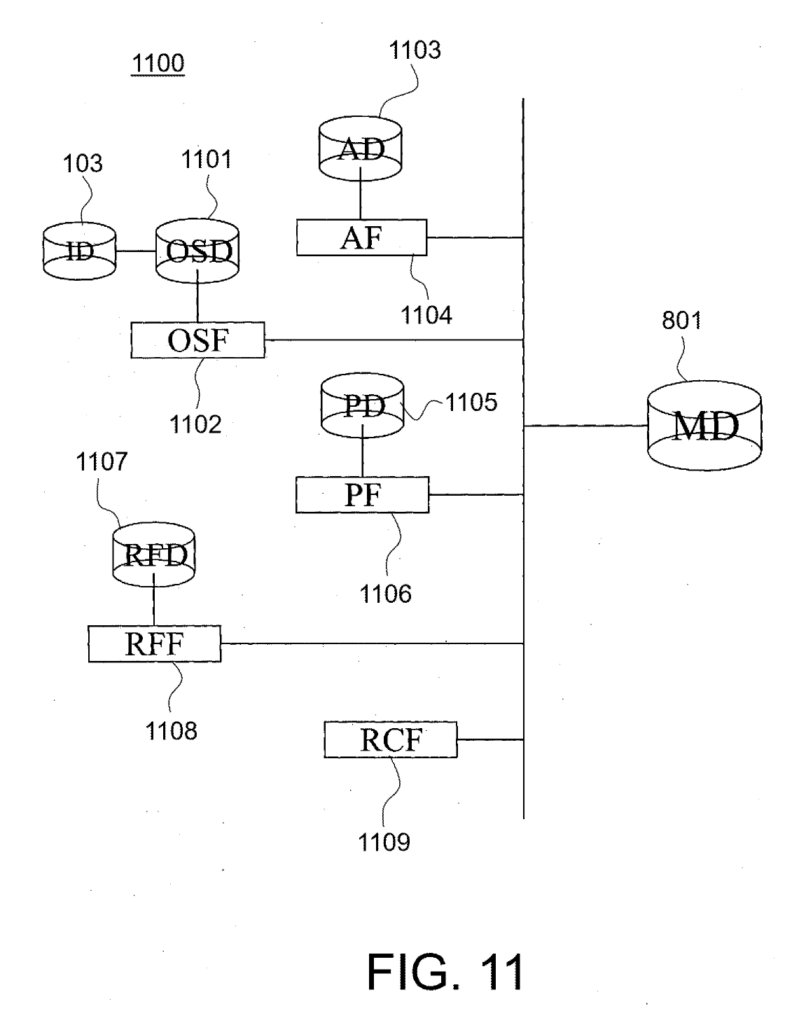

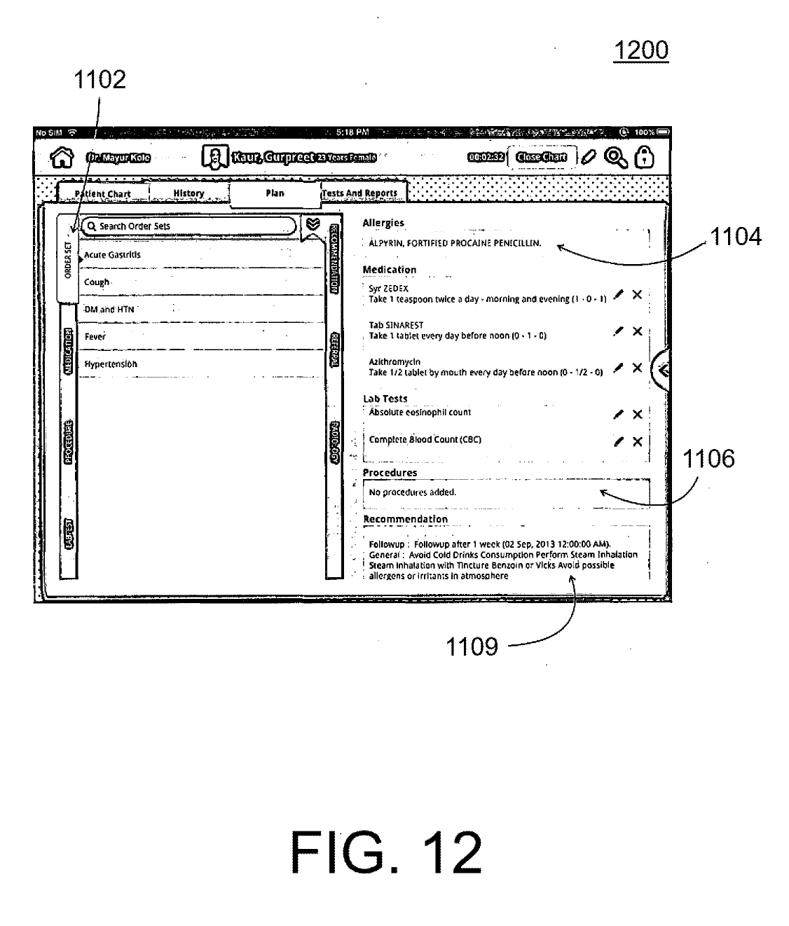

FIG. 11 illustrates a specially-configured hardware or software schematic that makes up an example embodiment healthcare input system 1100. FIG. 12 is an illustration of an example embodiment GUI 1200 rendered by example embodiment systems and methods on a computerized display.

As shown in FTG. 11, an order set database 1101 (OSD) defines and stores various order sets, which is a list of attributes relating to a treatment plan for a particular illness from illnesses database 103. For example, these attributes may include medication, test, recommendation, etc. relating to an illness. Order set database 1101 is linked with an order set field 1102 (OSF) that displays list order sets on GUI 1200 (FIG. 12). A doctor, for example, may select an order set from field 1102, and such selection may be highlighted. Depending upon an illness that is selected, a corresponding treatment plan may be activated for display by populating fields in the treatment plan view of example systems and methods. Order set database 1101 is linked with illnesses database 103 such that a user may select an illness.

As shown in FIG. 11, there is provided an allergies database 1103 (AD) that stores a list of allergies. Allergies database 1103 is linked with an allergies field 1104 (AF) that displays allergies as shown in example embodiment GUI 1200 (FIG. 12). For example, a doctor may select, through touch, gesture, input, click, etc., an allergy, per patient, from database 1103 via field 1104, and such selection may be highlighted. Allergies in database 1103 may be linked with medications from medicines database 801 such that medicine with contraindicating allergies for a patient are not activated or populated into relevant fields for selection, or so that a warning is given to a prescriber. Procedures database 1105 (PD) stores a list of procedures that may be prescribed to a patient. Procedures database 1105 is linked with procedures field 1106 that displays the procedures from database 1105 on example embodiment GUI 1200 (FIG. 12). In this way, a user may select a procedure through GUI 1200, and such selection may be highlighted. Referrals database 1107 (RFD) stores a list of referrals that may be prescribed to a patient. Referrals database 1107 is linked with a referrals field 1108 (RFF) that displays referrals from database 1107 on example embodiment GUI 1200 (FIG. 12). For example, the referrals may be specialist doctor referrals, and referrals database 1107 may store doctors' details in association with their specialties. As with other fields, referrals field 1108 may highlight a selected referral by a user made by a gesture, touch, click, etc. A recommendations field 1109 (RCF) is further presented in example embodiment GUI 1200 to allow for input of recommendations on a per patient basis for storage.

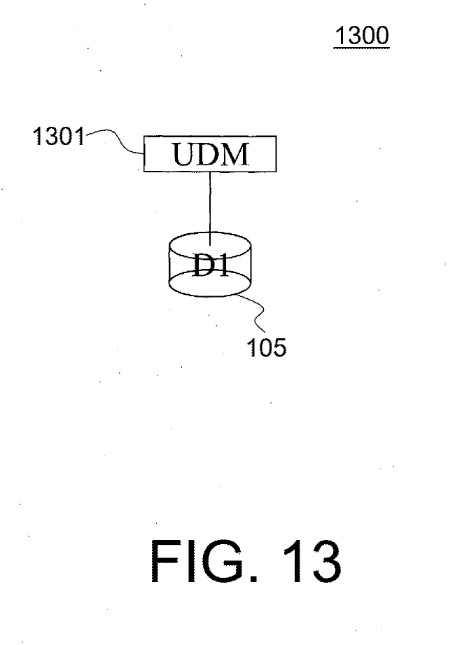

FIG. 13 illustrates a specially-configured hardware or software schematic that makes up an example embodiment healthcare input system 1300. As shown in FIG. 13, an updater 1301 (UDM) is configured to update first set of databases 105 (D1) with all data input or entered in association with a patient through example GUIs so as to store progress of patient. Example embodiment systems and GUIs can be invoked from updater 1301 to show a prognosis for a patient in a time-stamped and date-stamped manner.

The example systems, methods, and GUIs in FIGS. 1-13 and described above can be used together in a single program or may be used for their separate functionality. The example systems 100 and 200, and example GUI 300 permit input and ordered, associated storage of patient examination, including vital signs and symptoms, through a GUI requiring no typing by a user, such as an attending physician. Similarly, the example system 400 and GUI 500 permit input and ordered, associated ordered, associated storage of diagnosis information through a GUI requiring no typing by a user, such as the examining doctor. Similarly, the example system 600 and GUI 700 permit input and ordered, associated storage of patient test and test result data through a GUI requiring no typing by a user, such as a nurse practitioner. Still further, the example system 800 and GUIs 900 and 1000 permit input and ordered, associated storage of patient prescription information through a GUI requiring no typing by a user, such as a patient intake specialist. Still further, the example system 1100 and GUI 1200 permit input and ordered, associated storage of patient treatment plans through a GUI requiring no typing by a user, such as a home healthcare worker. Lastly, the example system 1300 permit input and ordered, associated storage of patient prognosis information through a GUT requiring no typing by a user, such as a health insurer. In this way, 1) examination; 2) diagnosis; 3) tests and results; 4) prescription; 5) treatment plan; and/or 6) prognosis, can be captured and tracked with respect to individual patients and individual healthcare interactions without a keyboard or typing required by the healthcare professional otherwise busy administering healthcare.

Database terms, including list items selectable by users in example systems, may be a predefined set of pre-configured clinical and/or medical terminology stored in the databases. This set of pre-configured clinical and/or medical terminology may be specialty-specific so as to permit healthcare workers to obtain access to their specific terminology set only with a touch based interface, without typing. Specialists can configure their clinical and/or medical terminology set as per their needs as a part of setting up their practice, thereby ensuring that they are able to further refine or classify or re-classify the available terminology set. Sets of updated and specialty-specific terminology may also be available for download or other transfer to provide desired customization. This set of clinical and/or medical terminology can be pre-defined across all the steps of a patient management flow; i.e. (i) examinations, (ii) diagnoses, (iii) tests and results, (iv) prescription of medication, (v) treatment plan(s), and (vi) prognoses. This set of pre-configured clinical and/or medical terminology allows a touch-only based interface where typing or a keyboard is not required.

A frequency response controller can compute frequency of use of each piece of terminology from predefined sets and use the same to prompt relatively more frequently used terminologies earlier or more promptly than others. Additionally, the frequency response controller can compute frequency of use of each piece of terminology in correlation with context and uses this correlative context to prompt relatively more frequently used terminologies earlier or more promptly than others, in correlation to the context at hand. The context may be geography, demographic, diagnosis data, clinical findings or the like. In any case, this intelligent suggesting improves a touch-based experience and by reducing the number of touch responses required for data entry.

Each GUI of FIGS. 3, 5, 7, 9, 10, and 12 present a template(s) stored in the described databases and displayed by a computer processor in example systems and methods. The templates may be specialty-specific, for example, providing doctors with a pre-configured flow across all the steps of patient management flow, i.e. (i) examinations, (ii) diagnoses, (iii) tests and results, (iv) prescription of medication, (v) treatment plan(s), and (vi) prognoses. Portions of the templates may be fixed and others dynamic in that they are items populated and/or selected from a pre-defined dataset among which a selection is made. Predefined or pre-configured template portions may correlate with set of pre-configured clinical and/or medical terminology so that the terminologies can be used as response inputs. This set of pre-configured templates permits a touch-only based interface where no additional, lengthy information from typing is required. Differing specialties and corresponding templates and terminology may be selected through touch. Auto-population functions discussed above can further auto-populate templates to a certain degree based on pre-defined parameters such as doctor-specialty configuration, patient-demographic configuration, patient-diagnosis configuration, patient-clinical finding configuration, and the like. The pre-defined set of pre-configured templates is useful in pre-configuring treatment plans via data order set templates and use them when documenting and recommending treatment protocol to patients.

The various controllers, counters, populators, assignors, suggestors, managers, and other related features of FIGS. 1, 2, 4, 6, 8, 11, and 13 are specifically-configured computer processor(s) and the various databases of FIGS. 1, 2, 4, 6, 8, 11, and 13 are information sources, such as linked or relational databases, that achieve the functionality of the GUIs of FIGS. 3, 5, 7, 9, 10, and 12 through hardware and software. Example systems and methods may be executed together, and example embodiment GUIs may be accessible through a single window, program, or application on a computer. Example embodiments and methods in their entirety may be executed by a single computer processor and attendant memory and bus, connected to an input-receptive display, or various components thereof may be executed by distinct processors, memories, servers, etc. distributed remotely from each other.

Some example methods being described here and in the incorporated documents, it is understood that one or more example methods may be used in combination and/or repetitively to produce multiple options and functionalities for subscribers. Example methods may be performed by properly programming or hardware configuring notification networks to receive healthcare information and subscriber information and act in accordance with example methods. Similarly, example methods may be embodied on non-transitory computer-readable media that directly instruct computer processors to execute example methods and/or, through installation in persistent memory, configure general-purpose computers connected to subscribers and healthcare information sources into specific healthcare notification networks that execute example methods.

The data, in each of the components, means, modules, mechanisms, units, devices of example systems and methods may be ‘encrypted’ and suitably ‘decrypted’ when required. Encryption can be accomplished using any encryption technology, such as the process of converting digital information into a new form using a key or a code or a program, wherein the new form is unintelligible or indecipherable to a user or a thief or a hacker or a spammer. The term ‘encryption’ includes encoding, compressing, or any other translating of the digital content. The encryption of the digital media content can be performed in accordance with any technology including utilizing an encryption algorithm. The encryption algorithm utilized is not hardware dependent and may change depending on the digital content. For example, a different algorithm may be utilized for different websites or programs. The term ‘encryption’ further includes one or more aspects of authentication, entitlement, data integrity, access control, confidentiality, segmentation, information control, and combinations thereof.

These example systems and methods can be made accessible through a portal or an interface which is a part of or may be connected to, an internal network or an external network, such as the Internet or any similar portal. The portals or interfaces are accessed by one or more of users through an electronic device, whereby the user may send and receive data to the portal or interface which gets stored in at least one memory device or at least one data storage device or at least one server, and utilizes at least one processing unit. The portal or interface in combination with one or more of memory device, data storage device, processing unit and serves, form an embedded computing setup, and may be used by, or used in, one or more of a non-transitory, computer readable medium. In at least one embodiment, the embedded computing setup and optionally one or more of a non-transitory, computer readable medium, in relation with, and in combination with the said portal or interface forms one of the systems of the invention. Typical examples of a portal or interface may be selected from but is not limited to a website, an executable software program or a software application.

The systems and methods may simultaneously involve more than one user or more than one data storage device or more than one host server or any combination thereof. In at least one embodiment, one or more user can be blocked or denied access to one or more of the aspects of the invention.

A user may provide user input through any suitable input device or input mechanism such as but not limited to a keyboard, a mouse, a joystick, a touchpad, a virtual keyboard, a virtual data entry user interface, a virtual dial pad, a software or a program, a scanner, a remote device, a microphone, a webcam, a camera, a fingerprint scanner, pointing stick, etc.

Example systems and methods can be practiced using computer processor-based devices which may be connected to one or more of other electronic devices with wires or wirelessly which may use technologies such as but not limited to, NFC, Bluetooth, Wi-Fi, Wimax. This will also extend to use of the aforesaid technologies to provide an authentication key or access key or electronic device based unique key or any combination thereof.

The described embodiments may be implemented as a system, method, apparatus or article of manufacture using standard programming and/or engineering techniques related to software, firmware, hardware, or any combination thereof. The described operations may be implemented as code maintained in a “non-transitory, computer readable medium”, where a processor may read and execute the code from the non-transitory, computer readable medium. A non-transitory, computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. The code implementing the described operations may further be implemented in hardware logic (e.g., an integrated circuit chip, Programmable Gate Array (PGA), Application Specific Integrated Circuit (ASIC), etc.). The term network means a system allowing interaction between two or more electronic devices, and includes any form of inter/intra enterprise environment such as the world wide web, Local Area Network (LAN), Wide Area Network (WAN), Storage Area Network (SAN) or any form of Intranet.

While code implementing the described operations may be transmitted in “transmission signals,” where transmission signals may propagate through space or through a transmission media, such as an optical fiber, copper wire, etc. in the form of a wireless signal, satellite transmission, radio waves, infrared signals, Bluetooth, etc., any claimed code or logic is stored in hardware or a non-transitory, computer readable medium at the receiving and transmitting stations or devices. Further, a device in which the code implementing the described embodiments of operations is encoded may comprise a non-transitory, computer readable medium or hardware logic. Of course, those skilled in the art will recognize that many modifications may be made to this configuration without departing from the scope of the present invention, and that the article of manufacture may comprise suitable information bearing medium known in the art.

Example systems and methods can use properly configured personal computers, tablet computers, mobile phones, laptop computers, palmtops, portable media players, and personal digital assistants connected to a display. In an embodiment, the computer readable medium data storage unit or data storage device, or input file may be selected from a set of but not limited to USB flash drive (pen drive), memory card, optical data storage discs, hard disk drive, magnetic disk, magnetic tape data storage device, data server and molecular memory.

Some example methods being described here and in the incorporated documents, it is understood that one or more example methods may be used in combination and/or repetitively to produce multiple options and functionalities for subscribers. Example methods may be performed by properly programming or hardware configuring systems for casting analysis to receive casting designs and act in accordance with example methods. Similarly, example methods may be embodied on non-transitory computer-readable media that directly instruct computer processors to execute example methods and/or, through installation in persistent memory, configure general-purpose computers connected to healthcare information sources into specific healthcare notification networks that execute example methods.

Example methods and embodiments thus being described, it will be appreciated by one skilled in the art that example embodiments may be varied through routine experimentation and without further inventive activity. For example, although simple gestures are used in example embodiments to input data in example GUIs, it is understood that other inputs, a speech-to-text converter may adapt speech to text and selections, may also achieve such functionality in example GUIs. Variations are not to be regarded as departure from the spirit and scope of the exemplary embodiments, and all such modifications as would be obvious to one skilled in the art are intended to be included within the scope of the following claims.

What is claimed is:

1. A computerized system for capturing electronic healthcare information without requiring verbal typing, the system comprising:
a display;
a database storing a first healthcare interaction graphical user interface (GUI) and a second healthcare interaction GUI, wherein the first healthcare interaction GUI displays fields and information for a first stage of a healthcare interaction and the second healthcare interaction GUI displays fields and information for a second stage of the healthcare interaction following the first stage in time; and
a computer processor coupled to the database and the display, wherein the processor is configured to,
display the first healthcare interaction GUI on the display,
display the second healthcare interaction GUI on the display in response to a user input that does not include verbal typing, and
record input entered into the first and the second healthcare interaction

2. The system of claim 1, wherein the database further stores a set of medical terminology, and wherein the first and the second healthcare interaction GUI include the medical terminology.

3. The system of claim 2, wherein the medical terminology is specific to a medical specialty, and wherein the processor is further configured to receive a selection that does not include verbal typing of the medical specialty before the displaying the first or the second healthcare interaction GUI.

4. The system of claim 2, wherein the processor is further configured to suggest input into the first or the second healthcare interaction GUI from the set of medical terminology, and further configured to determine a frequency of use input and to suggest relatively more frequently used inputs.

5. The system of claim 2, wherein the computer processor is further configured to suggest input into the second healthcare interaction GUI from the set of medical terminology based on input into the first healthcare interaction GUI.

6. The system of claim 1, wherein the first healthcare interaction GUI includes fields indicating, for a patient, at least one of an examination procedure, a diagnosis, and laboratory tests and results, and wherein the second healthcare interaction GUI includes different fields indicating, for the patient, at least a prescription, a treatment plan, and a prognosis.

7. The system of claim 1, wherein the processor is further configured to auto populate the first or the second healthcare interaction GUI with input.

8. The system of claim 7, wherein the database further stores a set of medical terminology, and wherein the processor is further configured to auto-populate the first and the second healthcare interaction GUI with the medical terminology.

9. The system of claim 1, wherein the second healthcare interaction GUI is selected based on input into the first healthcare interaction GUI indicating the second stage of the healthcare interaction.

10. The system of claim 9, wherein the database further stores a third healthcare interaction GUI with fields and information for a third stage of a healthcare interaction between the first stage and the second stage in time, and wherein the processor if further configured to skip the third healthcare interaction GUI based on the indicating.

11. The system of claim 1, wherein the processor is further configured to convert speech to text, and wherein the recording input does not include input by a user through an alphanumeric keyboard.

12. The system of claim 1, wherein the database further stores a set of body parts and a set of illnesses, wherein the first healthcare interaction GUI includes a first field listing the body parts and a second field listing the illnesses, and wherein the input entered into the first healthcare interaction GUI is a first selection made through touch of a subset of the body parts and a second selection made through touch of a subset of the illnesses.

13. The system of claim 12, wherein the touch is a user touching the first field or the second field on the display.

14. The system of claim 12, wherein the second field lists only a subset of the illnesses based on the first selection of the subset of the body parts.

15. The system of claim 1, wherein the database further stores a set of body parts and a set of symptoms, wherein the first healthcare interaction GUI includes a first field listing the body parts and a second field listing only a subset of the symptoms, wherein the input entered into the first healthcare interaction GUI is a first selection made through touch of a subset of the body parts, and wherein the subset of symptoms is based on the first selection of the subset of the body parts.

16. The system of claim 15, wherein the first healthcare interaction GUI displays fields related to examination, and wherein the second healthcare interaction GUI displays fields related to diagnosis including an aggregation of input into the first healthcare interaction GUI, and wherein the input into the second healthcare interaction GUI is a diagnosis based on the aggregation.

17. The system of claim 1, wherein,
the first healthcare interaction GUI displays fields related to examination, and wherein the second healthcare interaction GUI displays fields related to diagnosis, and
the database further stores a third healthcare interaction GUI with fields and information for a third stage of a healthcare interaction after the second stage in time and related to tests and test results, a fourth healthcare interaction GUI with fields and information for a fourth stage of a healthcare interaction after the third stage in time and related to prescription of medication, a fifth healthcare interaction GUI with fields and information for a fifth stage of a healthcare interaction after the fourth stage in time and related to a treatment plan, and a sixth healthcare interaction GUI with fields and information for a sixth stage of a healthcare interaction after the fifth stage and related to a prognosis.

18. The system of claim 17, wherein the database further stores a set of medical information, and wherein the first, second, third, fourth, fifth, and sixth healthcare interaction GUI include fields listing the medical information on the display for selection by a user without verbal typing.

19. The system of claim 18, wherein the medical information includes a set of normal results data, and wherein the third healthcare interaction GUI displays results data for a patient with a subset of the normal results data that corresponds to the same metric tested by the results data for the patient.

20. The system of claim 18, wherein the medical information includes a set of medications, and wherein the computer processor is further configured to suggest in or to populate the fifth healthcare interaction GUI with only a subset of the medications based on input into the second healthcare interaction GUI reflecting a diagnosis

21. The system of claim 18, wherein at least one of the first, second, third, fourth, fifth, and sixth healthcare interaction GUI include fields for receiving textual input, and wherein the computer processor is further configured to suggest or to populate the fields with completed textual input based on a user input of an incomplete word.

22. The system of claim 18, wherein the processor is further configured to record the user input in the first, second, third, fourth, fifth, and sixth healthcare interaction GUI in association with a date and time, a patient, and a healthcare interaction.

23. The system of claim 17, wherein the database further stores a set of medical information including dosage information and associated administration routes, wherein the fourth healthcare interaction GUI displays a subset of the dosage information and administration routes that corresponds to a medicine selected on the fourth healthcare interaction GUI, and wherein the subset of dosage information and administration routes is selectable as the user input.

24. A method of capturing electronic healthcare information without requiring verbal typing, the method comprising:
storing, in a database, a first healthcare interaction graphical user interface (GUI) and a second healthcare interaction GUI, wherein the first healthcare interaction GUI displays fields and information for a first stage of a healthcare interaction and the second healthcare interaction GUI displays fields and information for a second stage of the healthcare interaction following the first stage in time; and
displaying, with a computer processor, the first healthcare interaction GUI on a display,
displaying, with the computer processor, the second healthcare interaction GUI on the display in response to a user input that does not include verbal typing, and
recording, with the computer processor, input entered into the first and the second healthcare interaction GUI.

25. The method of claim 24, further comprising:
storing a set of medical terminology in the database, wherein the first and the second healthcare interaction GUI include the medical terminology.

26. The method of claim 25, wherein the medical terminology is specific to a medical specialty and wherein method further comprises:
receiving with the computer processor, a selection that does not include verbal typing of the medical specialty before the displaying the first or the second healthcare interaction GUI.

27. The method of claim 25, further comprising:
suggesting, with the computer processor, input into the first or the second healthcare interaction GUI from the set of medical terminology; and
determining a frequency of use input and to suggest relatively more frequently used inputs.

28. The method of claim 25, further comprising:
suggesting, with the computer processor, input into the second healthcare interaction GUI from the set of medical terminology based on input into the first healthcare interaction GUI.

29. The method of claim 24, wherein the first healthcare interaction GUI includes fields indicating, for a patient, at least one of an examination procedure, a diagnosis, and laboratory tests and results, and wherein the second healthcare interaction GUI includes different fields indicating, for the patient, at least a prescription, a treatment plan, and a prognosis.

30. The method of claim 24, further comprising:
auto-populating, with the computer processor, the first or the second healthcare interaction GUI with input.

31. The method of claim 30, further comprising:
storing, in the database, a set of medical terminology; and
auto-populating, with the computer processor, the first and the second healthcare interaction GUI with the medical terminology.

32. The method of claim 24, wherein the second healthcare interaction GUI is selected based on input into the first healthcare interaction GUI indicating the second stage of the healthcare interaction.

33. The method of claim 32, further comprising:
storing, in the database, a third healthcare interaction GUI with fields and information for a third stage of a healthcare interaction between the first stage and the second stage in time; and
skipping, with the computer processor, the third healthcare interaction GUI based on the indicating.

34. The method of claim 24, further comprising:
converting, with the computer processor, speech to text, and wherein the recording input does not include input by a user through an alphanumeric keyboard.

35. The method of claim 24, further comprising:
storing, with the database, a set of body parts and a set of illnesses, wherein the first healthcare interaction GUI includes a first field listing the body parts and a second field listing the illnesses, and wherein the input entered into the first healthcare interaction GUI is a first selection made through touch of a subset of the body parts and a second selection made through touch of a subset of the illnesses.

36. The method of claim 35, wherein the touch is a user touching the first field or the second field on the display.

37. The method of claim 35, wherein the second field lists only a subset of the illnesses based on the first selection of the subset of the body parts.

38. The method of claim 34, further comprising:
storing, in the database, a set of body parts and a set of symptoms, wherein the first healthcare interaction GUI includes a first field listing the body parts and a second field listing only a subset of the symptoms, wherein the input entered into the first healthcare interaction GUI is a first selection made through touch of a subset of the body parts, and wherein the subset of symptoms is based on the first selection of the subset of the body parts.

39. The method of claim 38, wherein the first healthcare interaction GUI displays fields related to examination, and wherein the second healthcare interaction GUI displays fields related to diagnosis including an aggregation of input into the first healthcare interaction GUI, and wherein the input into the second healthcare interaction GUI is a diagnosis based on the aggregation.

40. The method of claim 24, wherein,
the first healthcare interaction GUI displays fields related to examination, and wherein the second healthcare interaction GUI displays fields related to diagnosis, the method further comprising:
storing, in the database, a third healthcare interaction GUI with fields and information for a third stage of a healthcare interaction after the second stage in time and related to tests and test results, a fourth healthcare interaction GUI with fields and information for a fourth stage of a healthcare interaction after the third stage in time and related to prescription of medication, a fifth healthcare interaction GUI with fields and information for a fifth stage of a healthcare interaction after the fourth stage in time and related to a treatment plan, and a sixth healthcare interaction GUI with fields and information for a sixth stage of a healthcare interaction after the fifth stage and related to a prognosis.

41. The method of claim 40, further comprising:
storing, in the database, a set of medical information, and wherein the first, second, third, fourth, fifth, and sixth healthcare interaction GUI include fields listing the medical information on the display for selection by a user without verbal typing.

42. The method of claim 41, wherein the medical information includes a set of normal results data, and wherein the third healthcare interaction GUI displays results data for a patient with a subset of the normal results data that corresponds to the same metric tested by the results data for the patient.

43. The method of claim 41, wherein the medical information includes a set of medications, and wherein the computer processor is further configured to suggest in or to populate the fifth healthcare interaction GUI with only a subset of the medications based on input into the second healthcare interaction GUI reflecting a diagnosis

44. The method of claim 41, wherein at least one of the first, second, third, fourth, fifth, and sixth healthcare interaction GUI include fields for receiving textual input, and wherein the computer processor is further configured to suggest or to populate the fields with completed textual input based on a user input of an incomplete word.

45. The method of claim 41, further comprising:
recording the user input in the first, second, third, fourth, fifth, and sixth healthcare interaction GUI in association with a date and time, a patient, and a healthcare interaction.

46. The method of claim 40, further comprising:
storing, in the database, a set of medical information including dosage information and associated administration routes, wherein the fourth healthcare interaction GUI displays a subset of the dosage information and administration routes that corresponds to a medicine selected on the fourth healthcare interaction GUI, and wherein the subset of dosage information and administration routes is selectable as the user input.

47. The method of claim 45, wherein the method excludes any verbal typing for any input.
